(19) United States
(12) Patent Application Publication
(10) Pub. No.: US 2009/0201428 A1
(43) Pub. Date: Aug. 13, 2009

(54) MIXER CIRCUIT, SEMICONDUCTOR APPARATUS INCLUDING THE SAME, COMMUNICATION DEVICE INCLUDING THE SAME, AND ELECTRONIC DEVICE INCLUDING THE SAME

(76) Inventor: Shinpei Kubota, Amagasaki-shi (JP)

Correspondence Address: BIRCH STEWART KOLASCH & BIRCH, PO BOX 747, FALLS CHURCH, VA, 22040-0747, US

(21) Appl. No.: 12/345,742

(22) Filed: Dec. 30, 2008

(30) Foreign Application Priority Data
Feb. 8, 2008 (JP) 2008-029700

(51) Int. Cl. H04N 5/44; G06G 7/12

(52) U.S. Cl. 348/725; 327/355; 348/E05.096

(57) ABSTRACT

A mixer circuit 1 is a mixer circuit including a pair of differential transistors which receives an input signal IN₁-IN₂; and a serial resonance circuit 2 connected between collectors of transistors Q₁ and Q₂ of the pair of differential transistors, the mixer circuit mixing the input signal IN₁-IN₂ and a local signal LO₁-LO₂, and outputting the mixed signal.

This Nonprovisional application claims priority under U.S.C. §119(a) on Patent Application No. 029700/2008 filed in Japan on Feb. 8, 2008, the entire contents of which are hereby incorporated by reference.

### FIELD OF THE INVENTION

The present invention relates to a mixer circuit, a semiconductor apparatus including the mixer circuit, a communication device including the mixer circuit, and an electronic device including the mixer circuit.

### BACKGROUND OF THE INVENTION

A conventional mixer circuit is illustrated in FIG. 2.

An input signal IN₁ is inputted into a base of a transistor Q₁, while an inverting input signal IN₂ is inputted into a base of a transistor Q₂.

A local signal LO₁ is inputted into bases of transistors Q₃ and Q₆, while an inverting local signal LO₂ is inputted into bases of transistors Q₄ and Q₅.

Emitters of the transistors Q₁ and Q₂ are connected to an input of a common current source Iₒ, while an output of the current source Iₒ is electrically grounded.

A collector of the transistor Q₁ is connected to emitters of the transistors Q₃ and Q₄, while a collector of the transistor Q₂ is connected to emitters of the transistors Q₅ and Q₆.

An end of a load resistance R₁ is connected to a power source, while the other end is connected to collectors of the transistors Q₃ and Q₅. An end of a load resistance R₂ is connected to the power source, while the other end is connected to collectors of the transistors Q₄ and Q₆.

An output signal OUT₁ is outputted from a connection point of the collectors of the transistors Q₃ and Q₅. An inverting output signal OUT₂ is outputted from a connection point of the collectors of the transistors Q₄ and Q₆.

For convenience of description hereinafter, an input signal V_{IN}, a local signal V_{LO}, and an output signal V_{OUT} are defined as follows:

V_{IN}=IN₁−IN₂ (1)

V_{LO}=LO₁−LO₂ (2)

V_{OUT}=OUT₁−OUT₂ (3)

Also, a current of the current source I₀ is defined as I₀, and resistance values of the load resistances R₁ and R₂ are collectively defined as R.

A collector current I₁ of the transistor Q₁ and a collector current I₂ of the transistor Q₂ can be represented by the following formulas (4) and (5), respectively. At this point, VT=kT/q is thermal voltage, k is Boltzmann constant, q is unit charge of an electron, and T is absolute temperature.

$$\begin{matrix}{I}_{1} = \frac{{I}_{0}}{2 {V}_{T}} {V}_{IN} & ( 4 ) \\ {I}_{2} = - \frac{{I}_{0}}{2 {V}_{T}} {V}_{IN} & ( 5 )\end{matrix}$$

Similarly, a collector current I₃ of the transistor Q₃, a collector current I₄ of the transistor Q₄, a collector current I₅ of the transistor Q₅, and a collector current I₆ of the transistor Q₆ can be represented by the following formulas (6), (7), (8), and (9), respectively.

$$\begin{matrix}{I}_{3} = \frac{{I}_{1}}{2 {V}_{T}} {V}_{LO} = \frac{{I}_{0}}{4 {V}_{T}^{2}} {V}_{IN} \times {V}_{LO} ( ∵ ( 4 ) ) & ( 6 ) \\ {I}_{4} = - \frac{{I}_{1}}{2 {V}_{T}} {V}_{LO} = - \frac{{I}_{0}}{4 {V}_{T}^{2}} {V}_{IN} \times {V}_{LO} ( ∵ ( 4 ) ) & ( 7 ) \\ {I}_{5} = - \frac{{I}_{2}}{2 {V}_{T}} {V}_{LO} = \frac{{I}_{0}}{4 {V}_{T}^{2}} {V}_{IN} \times {V}_{LO } ( ∵ ( 5 ) ) & ( 8 ) \\ {I}_{6} = \frac{{I}_{2}}{2 {V}_{T}} {V}_{LO} = - \frac{{I}_{0}}{4 {V}_{T}^{2}} {V}_{IN} \times {V}_{LO} ( ∵ ( 5 ) ) & ( 9 )\end{matrix}$$

Consequently, the output signal V_{OUT} can be represented by the following formula (10). As shown in the formula (10), the output signal V_{OUT} includes a product of the input signal V_{IN} and the local signal V_{LO}.

$$\begin{matrix}{V}_{OUT} = {OUT}_{1} - {OUT}_{2} \\ = R ( {I}_{3} + {I}_{5} ) - R ( {I}_{4} + {I}_{6} ) \\ = \frac{{RI}_{0}}{{V}_{T}^{2}} {V}_{IN} \times {V}_{LO} ( ∵ ( 6 ) \sim ( 9 ) )\end{matrix} \qquad ( 10 )$$

Here, when frequencies of the input signal V_{IN}, local signal V_{LO}, and output signal V_{OUT} are respectively defined as f_{IN}, f_{LO}, and f_{OUT}, the frequency f_{OUT} can be represented by the following formula (11):

f_{OUT}=f_{IN}−f_{LO} (11)

Generally, such an operation to lower the frequency of the input signal by using the conventional mixer circuit shown in FIG. 2 is called “down converting”, and is employed in almost all of the receiving apparatuses.

A device including a mixer circuit that performs down converting like the conventional mixer circuit shown in FIG. 2 is disclosed in Japanese Unexamined Patent Application Publication, Tokukai, No. 2006-345009 (disclosed on Dec. 21, 2006). The device is a wideband frequency multiplier, which can convert a frequency of a fundamental wave of an input signal to a frequency multiplied by an odd number, so as to regulate an output amplitude and improve spurious characteristics.

The local signal V_{LO} to be inputted into the conventional mixer circuit shown in FIG. 2 is so-called a large signal. Not only the local signal V_{LO} having the frequency of f_{LO}, but also a signal having the frequency of 3f_{LO} (a third harmonic of the local signal V_{LO}) is inputted into the mixer circuit of FIG. 2 concurrently.

Recently, terrestrial digital broadcasting services for mobile terminal users, such as one-segment broadcasting (Japan) and DVB-H (Europe), have been rapidly becoming popular. On a mobile terminal that supports such services, receiving quality of the digital broadcasting channel is significantly deteriorated when the mobile terminal itself emits an interfering wave at a frequency equal to three times the frequency of a digital broadcasting channel.

The reason for the deterioration is because, for example, as shown in FIG. 3, when the one-segment broadcasting (f_{LO}=650 MHz) and a W-CDMA interfering wave (3f_{LO}=1950 MHz, the frequency equal to three times the frequency of the one-segment broadcasting) emitted from a mobile phone itself are received concurrently, mixing of the third harmonic occurs, and then a mixing component of the third harmonic of the local signal and the W-CDMA interfering wave of the mobile phone is down-converted to a desired band.

In the case in which a desired wave having a bandwidth of 430 kHz is down-converted to a IF frequency f_{IF}=500 kHz by using a Low-IF method like the one-segment broadcasting, a relation among the f_{IF}, f_{LO}, and f_{D} can be represented by the formula of f_{D}=(f_{LO}+f_{IF}), where the frequency of the desired wave is f_{D} and the frequency of the local signal is f_{LO}. In the case in which a frequency f_{U} (the frequency equal to three times the frequency of the desired wave) of the interfering wave is equal to a frequency that is represented by the following formula (12), the receiving quality is most deteriorated. Further, when the formula (12) is satisfied, a frequency of the mixing component of the third harmonic of the local signal (frequency: 3f_{LO}) and the interfering signal of the mobile phone (frequency: f_{U}) becomes equal to the frequency f_{D} of the desired wave.

f_{U}=3f_{LO}−f_{IF}=3(f_{D}−f_{IF})−f_{IF}=3f_{D}−4f_{IF} (12)

A tuner cannot distinguish signals identical in frequency, and tries to demodulate signals of the same frequency regardless whether the signal is a noise or not. On the other hand, the tuner distinguishes signals different in frequency, and does not demodulate a signal of unwanted frequency. A signal for mobile phones is an unwanted signal while receiving a signal of TV broadcast, so the signal for mobile phones is regarded as noise. If the unwanted signal widely overlaps the signal of TV broadcast, the receiving quality will be significantly deteriorated, compared to a case in which the unwanted signal appears at a different frequency from the signal of TV broadcast.

Moreover, while receiving digital TV broadcast whose frequency is 650 MHz, a relation between frequencies of the W-CDMA interfering wave (1950 MHz) and TV broadcast (650 MHz) is represented by a formula of f_{U}=3f_{D}. This affects watching quality of the one-segment broadcasting.

### SUMMARY OF THE INVENTION

The present invention is made to solve the above problem, and an object of the present invention is to provide a mixer circuit that can prevent deterioration of receiving performance by suppressing a mixing component of a third harmonic of a local signal and an interfering wave, and to provide a semiconductor apparatus, a communication device, and an electronic device each of which including the mixer circuit.

In order to attain the object, a mixer circuit according to the present invention comprises a pair of differential transistors which receives an input signal; and an LC resonance circuit connected between collectors of the differential transistors, and the mixer circuit mixes the input signal and a local signal, and outputs the mixed signal.

The present invention can significantly reduce a gain on a certain frequency, i.e., the frequency around a resonant frequency of the LC resonance circuit. As a result, the mixer circuit can suppress the third harmonic of the local signal, by matching the resonant frequency with a frequency of the third harmonic of the local signal. That is, on a system including the above mixer circuit, it is possible to suppress the mixing component of the third harmonic of the local signal and the interfering wave, and as a result, deterioration of receiving performance caused by the mixing component can be prevented.

### BRIEF DESCRIPTION OF THE DRAWINGS

FIG. 1 is a circuit diagram of a mixer circuit according to an embodiment of the present invention.

FIG. 2 is a circuit diagram of a conventional mixer circuit.

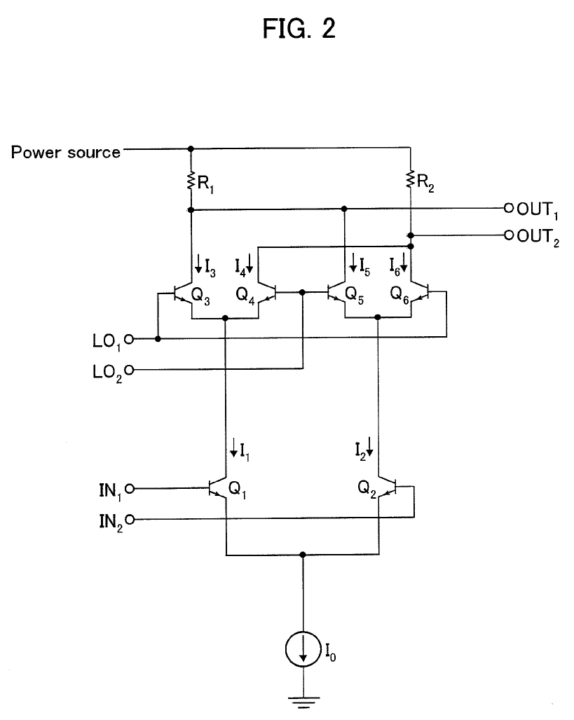

FIG. 3 is a view that illustrates an example of a bad effect caused by a mixing of a third harmonic.

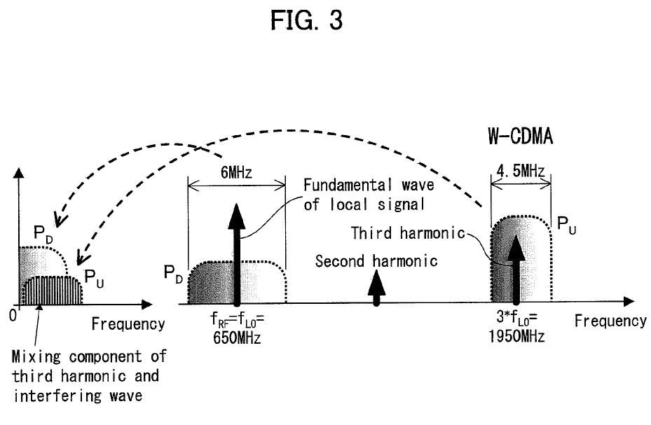

### DESCRIPTION OF THE EMBODIMENTS

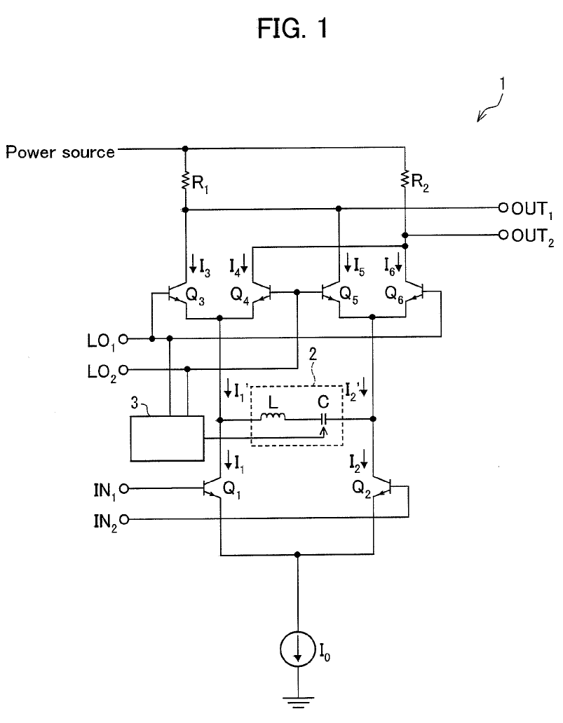

An embodiment of the present invention is described below with reference to FIG. 1.

FIG. 1 shows a circuit diagram of a mixer circuit 1 according to an embodiment of the present invention. The mixer circuit 1 includes transistors Q₁ to Q₆, load resistances R₁ and R₂, a current source Iₒ, an inductor L, and a capacitor C.

An input signal IN₁ is inputted into a base of the transistor Q₁, while an inverting input signal IN₂ is inputted into a base of the transistor Q₂.

A local signal LO₁ is inputted into bases of the transistors Q₃ and Q₆, while an inverting local signal LO₂ is inputted into bases of the transistors Q₄ and Q₅.

Emitters of the transistors Q₁ and Q₂ are connected to a common input of the current source I₀, while an output of the current source I₀ is electrically grounded.

A collector of the transistor Q₁ is connected to emitters of the transistors Q₃ and Q₄, while a collector of the transistor Q₂ is connected to emitters of the transistors Q₅ and Q₆.

An end of a load resistance R₁ is connected to a power source, while the other end is connected to collectors of the transistors Q₃ and Q₅. An end of a load resistance R₂ is connected to the power source, while the other end is connected to collectors of the transistors Q₄ and Q₆.

An output signal OUT₁ is outputted from a connection point of the collectors of the transistors Q₃ and Q₅. An inverting output signal OUT₂ is outputted from a connection point of the collectors of the transistors Q₄ and Q₆.

Inductor L and capacitor C constitute a serial resonance circuit, and are added between the collectors of the transistors Q₁ and Q₂. More specifically, an end of the inductor L is connected to the collector of the transistor Q₁, while the other end of the inductor L is connected to an end of the capacitor C. The other end of the capacitor C is connected to the collector of the transistor Q₂.

Here, an input signal V_{IN}, a local signal V_{LO}, and an output signal V_{OUT} are defined as follows:

V_{IN}=IN₁−IN₂ (13)

V_{LO}=LO₁−LO₂ (14)

V_{OUT}=OUT_{1-OUT}₂ (15)

Also, a current of the current source lo is defined as I₀, and resistance values of load resistances R₁ and R₂ are collectively defined as R.

An impedance Z of the serial resonance circuit 2 becomes minimum when a frequency of a current that flows in the serial resonance circuit 2 is equal to a resonance frequency f₀ that is represented by a formula (16):

$${f}_{0} = \frac{1}{2 π \sqrt{LC}} \qquad ( 16 )$$

When the impedance Z of the serial resonance circuit 2 is low, a difference between a current I₁′ and a current I₂′ becomes small. (The current I₁′ is outputted from a differential pair including the emitters of the transistors Q₃ and Q₄, and the current I₂′ is outputted from a differential pair including the emitters of the transistors Q₅ and Q₆.)

If I₁′=I₂′=I₀/2, currents I₃ to I₆, each of which flowing in the collectors of the transistors Q₃ to Q₆ respectively, can be represented by the following formulas (17) to (20).

$$\begin{matrix}{I}_{3} = \frac{{I}_{1}^{′}}{2 {V}_{T}} {V}_{LO} = \frac{{I}_{0}}{4 {V}_{T}} {V}_{LO} & ( 17 ) \\ {I}_{4} = - \frac{{I}_{1}^{′}}{2 {V}_{T}} {V}_{LO} = - \frac{{I}_{0}}{4 {V}_{T}} {V}_{LO} & ( 18 ) \\ {I}_{5} = - \frac{{I}_{2}^{′}}{2 {V}_{T}} {V}_{LO} = - \frac{{I}_{0}}{4 {V}_{T}} {V}_{LO} & ( 19 ) \\ {I}_{6} = \frac{{I}_{2}^{′}}{2 {V}_{T}} {V}_{LO} = \frac{{I}_{0}}{4 {V}_{T}} {V}_{LO} & ( 20 )\end{matrix}$$

Accordingly, the output signal V_{OUT} can be represented by the following formula (21), and if I₁′=I₂′=I₀/2, the mixer circuit 1 does not output a differential signal anymore. In reality, a minimum value of the impedance Z of the serial resonance circuit 2 does not reach zero because of an effect of a parasitic resistance or the like. However, with a signal whose frequency is around a resonance frequency f₀, the impedance Z becomes low, and so a gain can be reduced.

$$\begin{matrix}{V}_{OUT} = {OUT}_{1} - {OUT}_{2} \\ = R ( {I}_{3} + {I}_{5} ) - R ( {I}_{4} + {I}_{6} ) \\ = 0\end{matrix} \qquad ( 21 )$$

As described above, the mixer circuit 1 according to the embodiment can significantly reduce the gain on the frequency around the resonance frequency f₀. As a result, it is possible to suppress a third harmonic of the local signal V_{LO} by matching the resonance frequency f₀ with the frequency of the third harmonic of the local signal V_{LO}. Thus, on a system including the mixer circuit 1, it is possible to suppress a mixing component of the third harmonic of the local signal V_{LO} and an interfering wave, and as a result, deterioration of receiving performance caused by the mixing component can be prevented.

Furthermore, the mixer circuit 1 may be configured such that a switch is connected in series with the serial resonance circuit 2, so that the resonance circuit 2 can be separated off by turning off the switch. This configuration makes it possible to select whether to reduce the gain on the certain frequency, and also possible to select whether to suppress the mixing component, depending on a relation between frequencies of a desired wave and the interfering wave.

In the embodiment, a capacitance value of the capacitor C need not be a fixed value, and may be a variable. If the capacitance value is a variable, the resonance frequency f₀ can be varied, so that the mixing component can be suppressed in a wider frequency range.

In addition, the mixer circuit 1 may include a capacitance value variable segment 3. The capacitance value variable segment 3 varies the capacitance value of the capacitor C according to the frequency of the local signal V_{LO}. Specifically, the capacitance value variable segment 3 detects the change in the frequency of the local signal V_{LO} inputted into the capacitance value variable segment 3, and based on the change, the capacitance value variable segment 3 outputs a signal to the capacitor C, thereby varying the capacitance value of the capacitor C. The capacitance value variable segment 3 may be formed from a logic circuit or the like.

The frequency of the local signal V_{LO} is changed by, for example, a user who operates a tuner that includes the mixer circuit 1. For example, when the user sets a channel by operating a remote controller to watch a program of channel 13, the tuner starts operating so that the frequency of the local signal V_{LO} changes to a frequency corresponding to the channel 13. Inside the tuner, the frequency of the local signal V_{LO} is changed, and in the meantime, the capacitance value variable segment 3 generates a signal and sends the signal to the capacitor C, thereby varying the capacitance value of the capacitor C.

As described above, the capacitance value variable segment 3 can detect the change in the frequency of the local signal V_{LO}, and based on the change, the capacitance value variable segment 3 can output the signal to the capacitor C, thereby varying the capacitance value. Accordingly, the mixer circuit 1 can vary the capacitance value of the capacitor C according to the frequency of the local signal V_{LO}, and this makes it possible to always optimally select the resonance frequency f₀ even if the frequency of the local signal V_{LO} is changed. Consequently, the mixer circuit 1 can suppress the third harmonic of the local signal V_{LO}, and also can suppress the mixing component on the system including the mixer circuit 1, even if the frequency of the local signal V_{LO} is changed.

In the mixer circuit 1 according to the embodiment, the inductor L and the capacitor C may be formed on a semiconductor substrate. With this configuration, the problem associated with the mixing component can be solved simply with an IC.

The inductor L and the capacitor C may be chip components, instead of being formed on the semiconductor substrate. This configuration can achieve the resonance circuit having a high Q-value (acutance), and as a result, it is possible to suppress the mixing component more efficiently than the configuration in which the inductor L and the capacitor C are formed on the semiconductor substrate. Further, the inductor L may be formed from a WLCSP (wafer level chip size package) rewiring and the capacitor C may be the chip component. In this configuration, no inductor is provided inside the IC, and so it is possible to achieve a smaller chip area compared to the configuration in which the inductor L and the capacitor C are provided on the semiconductor substrate.

A semiconductor apparatus including the mixer circuit 1 shown in the embodiment can suppress the mixing component, and accordingly, a communication device including the semiconductor apparatus can prevent deterioration of receiving performance caused by the mixing component. The communication device may be a digital TV broadcasting receiver. In this case, deterioration of receiving performance caused by the mixing component while receiving digital TV broadcasting can be prevented. Consequently, an electronic device including one of the above communication devices can prevent deterioration of receiving performance caused by the mixing component.

### OVERVIEW OF THE EMBODIMENTS

A mixer circuit 1 according to the embodiment of the present invention comprises a pair of differential transistors which receives an input signal V_{IN}; and an LC resonance circuit 2 connected between collectors of the transistors Q₁ and Q₂ of the pair of differential transistors, and the mixer circuit 1 mixes the input signal V_{IN} and a local signal V_{LO}, and outputs the mixed signal.

The above configuration can significantly reduce a gain at a certain frequency, i.e., the frequency around a resonance frequency f₀ of the serial resonance circuit 2. Accordingly, the mixer circuit 1 can suppress a third harmonic of the local signal V_{LO} by matching a resonance frequency f₀ with a frequency of the third harmonic of the local signal V_{LO}. Thus, in a system including the mixer circuit 1, it is possible to suppress a mixing component of the third harmonic of the local signal V_{LO} and an interfering wave, and as a result, deterioration of receiving performance caused by the mixing component can be prevented.

In the mixer circuit 1, a switch may be connected in series with the serial resonance circuit 2.

In this configuration, the serial resonance circuit 2 can be separated off the mixer circuit 1 by turning off the switch. Therefore, it is possible to select whether to lower a gain on the certain frequency, and also possible to select whether to suppress the mixing component depending on a relation between frequencies of a desired wave and the interfering wave.

The mixer circuit 1 may be configured such that a capacitance value of a capacitor C on the serial resonance circuit 2 is a variable.

In this configuration, the resonance frequency f₀ can be varied, so it is possible to suppress the mixing component in a wider frequency range.

The mixer circuit 1 may include a capacitance value variable segment 3 that varies the capacitance value of the capacitor C according to a frequency of the local signal V_{LO}.

In this configuration, the capacitance value variable segment 3 detects a change in the frequency of the local signal V_{LO}. Based on the change, the capacitance value variable segment 3 outputs, for example, a signal to the capacitor C, thereby varying the capacitance value. As described above, since the mixer circuit 1 varies the capacitance value of the capacitor C according to the frequency of the local signal V_{LO}, the resonance frequency f₀ can always be optimally selected even when the frequency of the local signal V_{LO} is changed. Consequently, the mixer circuit 1 can suppress the third harmonic of the local signal V_{LO}, and also can suppress the mixing component in the system including the mixer circuit 1 even when the frequency of the local signal V_{LO} is changed.

In the mixer circuit 1, the inductor L and the capacitor C, each of which is included in the serial resonance circuit 2, may be formed on a semiconductor substrate.

With this configuration, the problem associated with the mixing component can be solved simply with an IC.

In the mixer circuit 1, the inductor L and capacitor C, each of which is included in the serial resonance circuit 2, may be chip components.

In this configuration, the resonance circuit having a high Q-value can be achieved, so it is possible to suppress the mixing component more efficiently than the configuration in which the inductor L and capacitor C are formed on the semiconductor substrate.

In the mixer circuit 1, the inductor L of the serial resonance circuit 2 may be formed from a WLCSP rewiring, while the capacitor C of the serial resonance circuit 2 may be the chip component.

In this configuration, no inductor is provided inside the IC, so it is possible to achieve a smaller chip area than the configuration in which the inductor L and capacitor C are provided on the semiconductor substrate.

A semiconductor apparatus according to the embodiment of the present invention includes the mixer circuit 1, so it is possible to suppress the mixing component.

A communication device according to the embodiment of the present invention includes the semiconductor apparatus, and as a result, deterioration of receiving performance caused by the mixing component can be prevented.

Further, the communication device according to the embodiment of the invention may be a digital TV broadcasting receiver. This can prevent deterioration of receiving performance caused by the mixing component, when receiving digital TV broadcasting.

An electronic device according to the embodiment of the present invention includes one of the communication devices, and as a result, deterioration of receiving performance caused by the mixing component can be prevented.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A mixer circuit comprising:
a pair of differential transistors which receives an input signal; and
an LC resonance circuit connected between collectors of the differential transistors,
the mixer circuit mixing the input signal and a local signal, and outputting the mixed signal.

2. The mixer circuit according to claim 1, further comprising a switch connected in series with the LC resonance circuit.

3. The mixer circuit according to claim 1, wherein the LC resonance circuit includes a capacitor having a variable capacitance value.

4. The mixer circuit according to claim 2, wherein the LC resonance circuit includes a capacitor having a variable capacitance value.

5. The mixer circuit according to claim 3, further comprising:
capacitance value variable means for varying the capacitance value of the capacitor according to a frequency of the local signal.

6. The mixer circuit according to claim 4, further comprising:
capacitance value variable means for varying the capacitance value of the capacitor according to a frequency of the local signal.

7. The mixer circuit according to claim 1, wherein the LC resonance circuit includes an inductor and a capacitor on a semiconductor substrate.

8. The mixer circuit according to claim 1, wherein the LC resonance circuit includes an inductor and a capacitor, each of which is a chip component.

9. The mixer circuit according to claim 1, wherein the LC resonance circuit includes an inductor and a capacitor, the inductor being formed from a WLCSP rewiring and the capacitor being a chip component.

10. A semiconductor apparatus including a mixer circuit as set forth in claim 1.

11. A communication device including a semiconductor apparatus as set forth in claim 10.

12. The communication device according to claim 11, being a digital TV broadcasting receiver.

13. An electronic device including a communication device as set forth in claim 11.

14. An electronic device including a communication device as set forth in claim 12.
